(19) United States
(12) Patent Application Publication
(10) Pub. No.: US 2026/0317165 A1
(43) Pub. Date: Oct. 15, 2026

(54) APPARATUS AND METHOD FOR CATALYTIC PYROLYSIS OF LIGHT HYDROCARBONS

(71) Applicant: Innova Cleantech Corp., Calgary (CA)

(72) Inventors: BOBOCEL Camille Donald, Rocky View County (CA); DESROCHES Matthew, Calgary (CA); GILES Lee Kamelia, Calgary (CA)

(21) Appl. No.: 19/174,302

(22) Filed: Apr. 9, 2025

(51) Int. Cl. C01B 3/26; B01J 8/00; B01J 8/02; B01J 8/08; B01J 8/18; B01J 8/24; C01B 3/28

(52) U.S. Cl. CPC C01B 3/26; B01J 8/0015; B01J 8/006; B01J 8/0278; B01J 8/0285; B01J 8/085; B01J 8/087; B01J 8/1827; B01J 8/1836; B01J 8/24; C01B 3/28; B01J 2208/00176; B01J 2208/00752; B01J 2208/00876; C01B 2203/0277; C01B 2203/1011; C01B 2203/1047; C01B 2203/1241

(57) ABSTRACT

A method for producing graphene and hydrogen, the method comprising: heating a hydrocarbon feed comprising light hydrocarbons to about 500 °C to create a pre heated hydrocarbon feed; in a first reactor, heating ferrocene to above a sublimation temperature of the ferrocene; introducing a portion of the pre heated hydrocarbon feed to the first reactor wherein the light hydrocarbons react with the ferrocene to produce a mixture comprising light hydrocarbon gas and sublimated ferrocene; combining with the preheated hydrocarbon feed the mixture comprising light hydrocarbon gas and sublimated ferrocene to produce a reactor feed stream; and introducing the main reactor feed to a second reactor operated at about 1000 °C to create a product mixture comprising hydrogen and solid carbon particles.

### CROSS-REFERENCE TO RELATED APPLICATIONS

The present application is a continuation of PCT Application No. PCT/CA2022/051502 filed on Oct. 12, 2022, incorporated herein by reference in its entirety.

### TECHNICAL FIELD

The following generally relates to carbon and hydrogen production by pyrolysis of hydrocarbons. More particularly, the present disclosure relates to apparatus and methods for producing various forms of solid carbon by pyrolysis of light hydrocarbons, such as methane, in the presence of a catalyst, and isolating and recovering the hydrogen and the produced solid carbon.

### BACKGROUND

Graphene is an allotrope of carbon consisting of a single layer of atoms arranged in a two-dimensional lattice. Since its inception, graphene has been found to be useful in many areas including, but not limited to, water purification, medicine, construction, electronic chips, and quantum computers. Each of these uses generally requires a graphene material having specific properties which can change depending on, for example, the length and number of graphene layers forming the graphene material.

Some existing methods of forming graphene involve catalytic pyrolysis of hydrocarbons, such as methane or natural gas, into solid carbon and hydrogen. In such processes, the produced hydrogen is often an unused or undesired byproduct.

Industrial demand for solid carbon and hydrogen continues to increase; thus, there exists an ongoing need to develop improved methods and apparatus for generating solid carbon and hydrogen.

### SUMMARY

Provided herein are a method and apparatus for producing solid carbon (e.g., graphite, graphene, carbon fibers, carbon nanotubes, fullerenes, onions, and the like) by pyrolysis of hydrocarbons from a hydrocarbon feedstock and for recovering hydrogen gas which is a byproduct of the pyrolysis, and which may also be present in the hydrocarbon feedstock.

In one aspect, provided is an apparatus for solid carbon (e.g., graphite, graphene, carbon fibers, carbon nanotubes, fullerenes, and the like) and hydrogen production, the apparatus comprising: an elongate reactor having: a first end and a second end, the first end being configured to receive a hydrocarbon feedstock; a channel defined therein for conveying a fluid between the first and second ends, wherein the fluid is a reaction mixture comprising the hydrocarbon feedstock; a terminal section attached to the second end, the terminal section being selectively permeable to hydrogen gas and impermeable to other components of the reaction mixture; and a hydrogen collection section attached to the second end to receive hydrogen gas from the terminal section, the hydrogen collection section being impermeable to hydrogen gas.

In an implementation, the reactor further comprises an inlet intermediate the first and second ends, the inlet being for addition of catalytic metallic particles to the reaction mixture.

In another implementation, the reactor is made from iron.

In yet another implementation, the terminal section is made from stainless steel.

In yet another implementation, the reactor further comprises at least one heating element for heating the reaction mixture in the channel.

In yet another implementation, the reactor further comprises a sleeve provided there-around near the at least one heating element, the sleeve being made from a hydrogen impermeable material and defining a sealed space between the sleeve and the reactor.

In yet another implementation, the hydrogen impermeable material is a ceramic material.

In yet another implementation, the channel comprises catalytic packing in the form of metal beads.

In yet another implementation, the metal beads are ferrous.

In another aspect, provided is a method for producing solid carbon (e.g., graphite, graphene, carbon fibers, carbon nanotubes, fullerenes, and the like) and hydrogen, the method comprising: introducing a hydrocarbon feed into a first region of a reactor; heating the first region to about 300 °C or higher to decompose hydrocarbons therein to create a reaction mixture comprising nascent carbon; introducing the reaction mixture to a second region of the reactor; heating the second region to about 1000 °C or higher and reacting the nascent carbon with catalytic metallic particles to generate solid carbon (e.g., graphite, graphene, carbon fibers, carbon nanotubes, fullerenes, and the like) fibers; and extracting hydrogen gas from the reaction mixture as the mixture exits the second region and contacts a terminal end of the reactor that is covered with a material permeable only to hydrogen gas.

In an implementation, the reaction mixture comprises entrained catalytic metallic particles/compounds.

In another implementation, an inner surface of the second region is nucleated with metallic catalytic particles/compounds before the hydrocarbon feed is introduced into the reactor.

In yet another aspect, provided is a method for producing solid carbon and hydrogen, the method comprising: heating a hydrocarbon feed comprising light hydrocarbons to about 500 °C to create a pre heated hydrocarbon feed; in a first reactor, heating one or more metallic catalytic compounds to above a sublimation temperature of the one or catalytic compounds; introducing a portion of the pre heated hydrocarbon feed to the first reactor wherein the light hydrocarbons react with the one or more metallic catalytic compounds (which may initially be in the form of solid particles) to produce a mixture comprising light hydrocarbon gas and one or more sublimated metallic catalytic compounds; combining with the preheated hydrocarbon feed the mixture comprising light hydrocarbon gas and the sublimated one or more metallic catalytic compounds to produce a reactor feed stream; and introducing the main reactor feed to a second reactor operated at about 1000 °C to create a product mixture comprising the hydrogen and the solid carbon.

In yet another aspect, provided is a method for producing solid carbon and hydrogen, the method comprising: heating a hydrocarbon feed comprising light hydrocarbons to about 500 °C to create a pre heated hydrocarbon feed; in a first reactor, heating one or more metallic catalytic compounds (which may initially be in the form of solid particles) to above a sublimation temperature of the one or more metallic catalytic compounds; introducing the pre heated hydrocarbon feed to the first reactor wherein the light hydrocarbons react with the one or more metallic catalytic compounds to produce a reactor feed stream comprising light hydrocarbon gas and sublimated metallic catalytic compounds; and introducing the reactor feed stream to a second reactor operated at about 1000 °C to create a product mixture comprising the hydrogen and the solid carbon.

In yet another aspect, provided is a method for producing solid carbon and hydrogen, the method comprising: heating a hydrocarbon feed comprising light hydrocarbons to about 500 °C to create a pre heated hydrocarbon feed; introducing solid particles of one or more metallic catalytic compounds into the pre heated hydrocarbon feed and using vibration or ultra sonic tools to suspend the solid particles in the pre heated hydrocarbon feed, thereby creating a reactor feed stream; and introducing the reactor feed stream to a second reactor operated at about 1000 °C to create a product mixture comprising the hydrogen and the solid carbon.

In yet another aspect, provided is a method for producing solid carbon and hydrogen, the method comprising: introducing a hydrocarbon feed stream comprising light hydrocarbons into a catalytic pyrolysis reactor, wherein the reactor is: a packed bed reactor containing solid particles comprising metallic catalytic compounds, the particles having a size of from about 5 mm to about 50 mm; or a fluidized bed reactor containing particles comprising metallic catalytic compounds having a size of from about 1 mm to about 10 mm; to produce a product mixture comprising the hydrogen and the solid carbon.

In some implementations, the metallic catalytic compound comprises iron.

In some implementations the one or more metallic catalytic compounds are ferrocene.

In some implementations, the solid carbon comprises solid carbon (e.g., graphite, graphene, carbon fibers, carbon nanotubes, fullerenes, and the like).

In some implementations, the light hydrocarbons comprise methane.

In yet another aspect, provided is an apparatus for catalytic pyrolysis of light hydrocarbons, the apparatus comprising: a first end and a second end, the first end being configured to receive a feed comprising the light hydrocarbons; a channel defined therein for conveying a fluid between the first and second ends, wherein the fluid is a reaction mixture comprising the light hydrocarbons, wherein the channel is defined by a material permeable to hydrogen; the channel including one or more metallic catalytic compounds (which may in the form of solid particles) for catalytic conversion of the light hydrocarbons to hydrogen and solid carbon; and a compartment or outlet for removing hydrogen that passes through the material permeable to hydrogen.

In some implementations, the metallic catalytic compounds comprise iron.

In some implementations, the one or more metallic catalytic compounds are ferrocene.

In some implementations, the solid carbon comprises solid carbon (e.g., graphite, graphene, carbon fibers, carbon nanotubes, fullerenes, and the like).

In some implementations, the light hydrocarbons comprise methane.

### BRIEF DESCRIPTION OF THE DRAWINGS

Embodiments will now be described with reference to the appended drawings wherein:

FIG. 1 is a cross-sectional view of an example embodiment of an apparatus for solid carbon (e.g., graphite, graphene, carbon fibers, carbon nanotubes, fullerenes, and the like) and hydrogen production.

FIG. 2 is a cross-sectional view of another example embodiment of an apparatus for solid carbon (e.g., graphite, graphene, carbon fibers, carbon nanotubes, fullerenes, and the like) and hydrogen production, the apparatus being further configured to control hydrogen content therein.

FIG. 3 illustrates a schematic illustration of a reactor and heating system for producing solid carbon (e.g., graphite, graphene, carbon fibers, carbon nanotubes, fullerenes, and the like) and hydrogen.

FIG. 4 illustrates a system for producing solid carbon (e.g., graphite, graphene, carbon fibers, carbon nanotubes, fullerenes, and the like) and hydrogen.

FIG. 5 illustrates a system for producing solid carbon (e.g., graphite, graphene, carbon fibers, carbon nanotubes, fullerenes, and the like) and hydrogen.

FIG. 6 illustrates a packed bed reactor for producing solid carbon (e.g., graphite, graphene, carbon fibers, carbon nanotubes, fullerenes, and the like) and hydrogen.

FIG. 7 is a more detailed version of a process similar to that illustrated in FIG. 3,

FIG. 8 illustrates an example embodiment of a reactor vessel for catalytic pyrolysis of hydrocarbons into solid carbon (e.g., graphite, graphene, carbon fibers, carbon nanotubes, fullerenes, and the like) and hydrogen.

FIG. 9 illustrates another example embodiment of a reactor vessel for catalytic pyrolysis of hydrocarbons into solid carbon (e.g., graphite, graphene, carbon fibers, carbon nanotubes, fullerenes, and the like) and hydrogen.

FIG. 10 is a more detailed version of a process similar to that illustrated in FIG. 4.

FIG. 11 illustrates another example embodiment of a process for the catalytic conversion of a hydrocarbon feed into solid carbon (e.g., graphite, graphene, carbon fibers, carbon nanotubes, fullerenes, and the like) and hydrogen.

FIG. 12 illustrates yet another example embodiment of a process for the catalytic conversion of a hydrocarbon feed into solid carbon (e.g., graphite, graphene, carbon fibers, carbon nanotubes, fullerenes, and the like) and hydrogen.

FIG. 13 illustrates yet another example embodiment of a process for the catalytic conversion of a hydrocarbon feed into solid carbon (e.g., graphite, graphene, carbon fibers, carbon nanotubes, fullerenes, and the like) and hydrogen.

FIG. 14 illustrates yet another example embodiment of a process for the catalytic conversion of a hydrocarbon feed into solid carbon (e.g., graphite, graphene, carbon fibers, carbon nanotubes, fullerenes, and the like) and hydrogen.

FIG. 15 illustrates yet another example embodiment of a process for the catalytic conversion of a hydrocarbon feed into solid carbon (e.g., graphite, graphene, carbon fibers, carbon nanotubes, fullerenes, and the like) and hydrogen.

FIG. 16 illustrates yet another example embodiment of a process for the catalytic conversion of a hydrocarbon feed into solid carbon (e.g., graphite, graphene, carbon fibers, carbon nanotubes, fullerenes, and the like) and hydrogen.

### DETAILED DESCRIPTION

One or more of the terms “front”, “back”, “rear”, “vertical”, “vertically”, “horizontal”, “horizontally”, “top”, “bottom”, “upwardly”, “downwardly”, “inwardly”, “outwardly”, “upper”, “lower”, “right” and “left” are used throughout this specification. It will be understood that these terms are not intended to be limiting. These terms are used for convenience and to aid in describing the features herein, for instance as illustrated in the accompanying drawings.

The following describes a method and apparatus for producing solid carbon (e.g., graphite, graphene, carbon fibers, carbon nanotubes, fullerenes, and the like) by pyrolysis of hydrocarbons from a hydrocarbon feedstock and for recovering hydrogen gas which is a byproduct of the pyrolysis and may be present in the hydrocarbon feedstock.

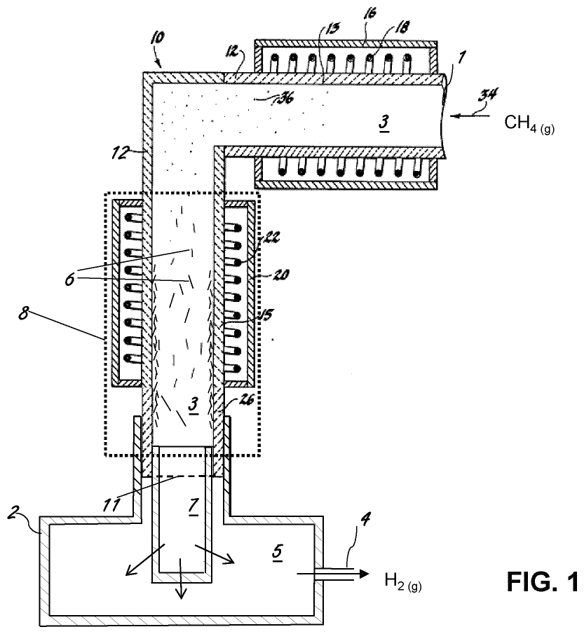

FIG. 1 illustrates an apparatus, or reactor 10, for the production of solid carbon (e.g., graphite, graphene, carbon fibers, carbon nanotubes, fullerenes, and the like) and hydrogen. The reactor 10 comprises a tube 12 defining a continuous gas passage 3 between a first end, or inlet 1, and a second end, or outlet 11 of the tube 12. A feedstock 34 (which may also be referred to herein as “process gas”) containing hydrocarbons, such as methane or natural gas, may flow through the inlet. A furnace 16 comprising a helical electrical resistance heating element 18 may be provided around the reactor 10 to heat a first reaction zone 13 within tube 12. Similarly, a second furnace 20 comprising a helical electrical resistance heating element 22 may be provided around the reactor 10 to heat a second reaction zone 15 within tube 12.

In alternative embodiments, there may be a plurality of tubes 12 and/or the tubes 12 may define a curved or straight continuous gas passage 3. Although two heating elements (18,22) and furnaces (16,20) are shown, the reactor 10 may comprise any number of heating elements/furnaces (collectively, “heating elements”). The heating elements can be of any suitable type such as, for example, standard, induction or flame heating elements.

The heating elements 18 and 22 may be heated to appropriate temperatures to create a desired temperature profile within the tube 12 to produce solid carbon (e.g., graphite, graphene, carbon fibers, carbon nanotubes, fullerenes, and the like). For example, the elements 18 and 22 may be operated such that the tube 12 has a lower temperature (e.g., 300 °C) in a zone 13 near the inlet 1 and a higher temperature in a zone 15 near the outlet 11 (e.g., 1000 °C). The hydrocarbon feedstock 34 can be diluted with other gases, such as hydrogen. The flowrate of the feedstock 34 into the tube 12 may be adjusted as desired. It may be that a higher flowrate of the feedstock 34 into the tube 12 may yield longer and/or thinner graphene fibers 6 in addition to other solid carbon products. Various elements, primarily metals, may be combined with the gas stream 3 at zone 13, for example, in the form of organic or inorganic salts.

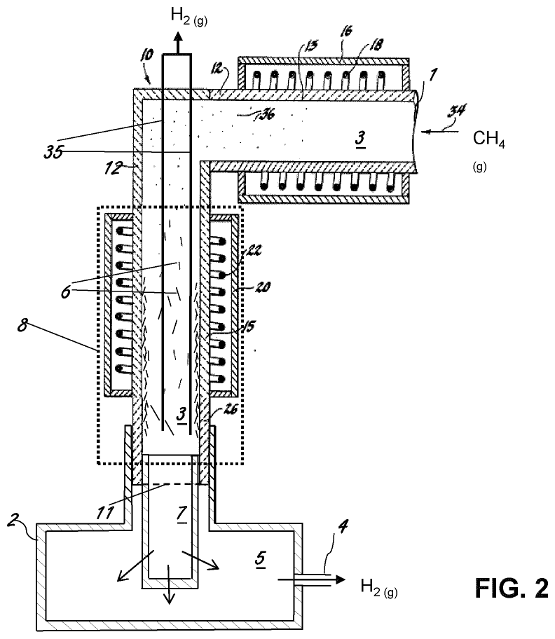

In one embodiment, iron pentacarbonyl vapors can be fed into or upstream of zone 13. As the gas flows through heated zone 13, the metal compound—an iron compound, in this example—can decompose to produce iron particles 36, the sizes of which are exaggerated in FIGS. 1 and 2 for ease of illustration. The metal catalytic compound, which may be iron, as mentioned, may be referred to hereinafter as “catalyst”.

Iron particles 36 may be entrained in the gas stream and carried through the tube 12 toward the outlet 11. Within heated zone 15, methane from the natural gas can be decomposed. The resulting nascent carbon may react with the iron particles 36 to produce microscopic graphene filaments 6. Deposition of additional nascent carbon may thicken any produced graphene filaments 6 by layering thereon additional individual filaments. The graphene filaments 6 and/or any other produced solid carbon subspecies may be collected in any suitable manner once the reaction is complete. For example, a suitable tool, such as a ring or set of rings configured for insertion into the tube 12 to scrape, or knock the solid carbon (e.g., graphite, graphene, carbon fibers, carbon nanotubes, fullerenes, and the like) off inner walls of the tube 12, may be used.

The reactor 10 may comprise an end section 7 that is made of a material that is permeable to hydrogen gas and substantially or completely impermeable to other gases in the tube 12, such as methane or inert gases. The end section 7 may be attached (e.g., threadedly or by welding) to the outlet 11 of the tube 12. During pyrolysis of the hydrocarbon feedstock, hydrogen may pass through the end section 7 (see arrows 19) into a hydrogen collection section 2 which may be made from a material being impermeable to hydrogen or resistant to passage of hydrogen therethrough, such as a ceramic material or iron. The hydrogen 5 may then exit the collection section 2 through an outlet 4 defined therein, and may be further processed or stored (not shown).

It may be that under certain conditions, such as high heat and/or pressure, the tube 12, which is made from iron in this example embodiment, may permit some hydrogen to pass therethrough. Thus, optionally, the apparatus 10 may include an impermeable (to hydrogen) sleeve 8 provided around the tube 12 and heater 20 to collect any hydrogen that may pass through the tube 12. The sleeve 8 may be made from or include a hydrogen impermeable material such as, for example, a ceramic material or iron. Any number of such sleeves 8 may be installed as needed.

Turning to FIG. 2, the apparatus 10 may further comprise one or more hydrogen collecting lines 35 made from a hydrogen permeable material such as, for example, 304 Stainless Steel. The lines 35 can be used to remove hydrogen from within the tube 12 and may provide some degree of control over the hydrogen content within the reactor 10, which may be beneficial to the pyrolysis reaction. Such lines 35 may also increase turbulence within the tube 12. It may be that increased turbulence increases uniformity of graphene distribution on the tube 12 walls. Alone or in combination with the lines 35, other objects or modifications to the tube 12 may be used to increase turbulence therein. In some embodiments, plasma and/or microwave heating may be used alone or in combination with the aforementioned heaters. In some embodiments, the tube 12 may be made from a ceramic material or another material impermeable to hydrogen gas. In some embodiments, a device for collecting graphene (and other solid carbon subspecies) such as a fabric or mesh filter may be installed within the tube 12. In some embodiments, the tube 12 is a tubular iron reactor, and graphene fibers 6 and other solid carbon subspecies may grow upon an interior wall of the tube 12 and primarily within region 15. The primary location of graphene fiber 6 and/or growth/deposition or other solid carbon subspecies may vary depending on factors such as tube 12 dimensions and temperature profile therein.

Various metal particles may be obtained from suitable precursor compounds and used as nuclei for graphene filament formation. Iron particles, for example, may be formed by evaporating a ferric nitrate solution on a suitable surface and decomposing the resulting iron oxide residue. Nucleation effectiveness can be dependent at least in part on the metal particle size, and thus metal particle size (degree of coalescence of the elemental metal) may be adjusted depending on, for example, desired graphene filament growth rate and properties. As understood by a person skilled in the art, dissociation rate and particle forming kinetics are dependent on temperature and may change depending on the metal precursor used. Generally, one or more variables such as, for example, the temperature profile across the tube 12, dimensions and configuration of the tube 12, location of entry of metal precursor, type of metal nuclei and gas stream flow rate may be tailored to achieve a desired type of graphene.

In some embodiments, fibers may be grown on the interior surface of the tube 12, having deposited thereon metal nuclei. Prior to initiation of pyrolysis, the interior wall may be nucleated by in-situ decomposition of a metal precursor compound, such as an iron carbonyl compound. In an implementation, the metal precursor may be iron pentacarbonyl, Fe(CO)₅, which may be injected into a stream of ambient temperature inert gas (e.g. argon), whereupon the iron carbonyl vaporizes. The inert gas stream may carry the vapors into the reactor and the flow rate of the stream may be controlled to achieve a desired dispersion of iron particles within the tube 12.

As discussed below, in some aspects, the catalyst may react with a stream (102) which may primarily consist of methane gas which may contain small amounts of other hydrocarbon gases, for example, ethane, propane or other gases often found in trace amounts in oil field production gases. Added to or included in the oil field gases may be H₂S, mercaptans, and/or other sulfur containing compounds. It may be that such sulfur gases may be important in forming various types of graphite, graphene and other solid carbon subspecies.

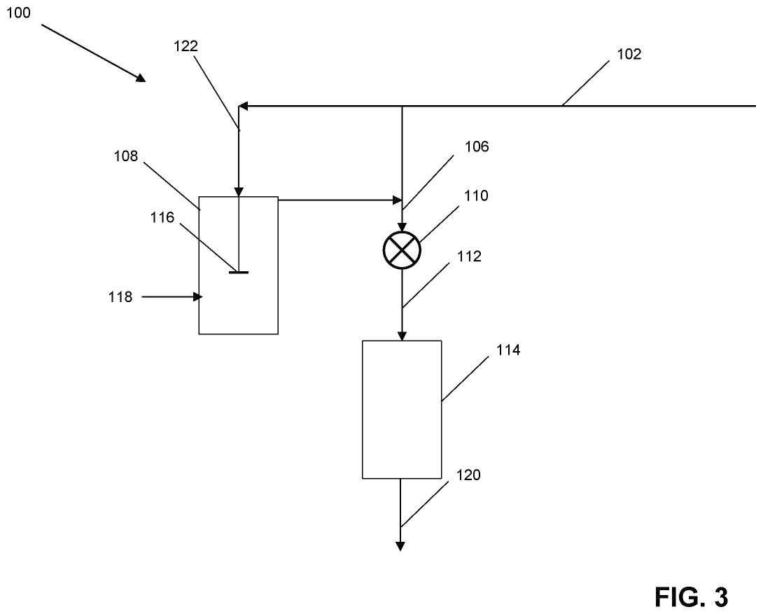

In some embodiments, e.g., as shown in FIG. 3 which depicts a reactor system 100, the catalyst may be provided as a gas suspension that is mixed with a feed stream 102 (which may be referred to as “methane gas” or “methane gas stream”) which may primarily consist of methane gas preheated to 500 degrees centigrade at a heater (110). Feed stream 102 may be at ambient temperature prior to pre-heating at the heater 110. More than one pre-heater may be included. Part of the methane gas stream (i.e., feed stream 102) may first be diverted through a catalyst solution 118 to bubble through the liquid and leave carrying the suspended catalyst. A diffuser 116 may be used for bubbling the liquid through the liquid catalyst solution 118 in another vessel 108. The combined stream 106 then may enter an open reactor 114 where it may be heated to between 950 to 1100 degrees centigrade depending on the catalyst used. A pre-heater 110 (which may be, e.g., a resistance, induction, plasma, microwave, or flame powered heater) may created a pre-heated reactor feed 112 which enters the open reactor 114. Solid carbon, e.g., graphite, graphene, carbon fibers, carbon nanotubes, fullerenes, and the like, along with hydrogen, methane, and reaction by products may be produced in such reactor 114, and more generally as an output 120 of reactor system 100 depicted in FIG. 3. Which, as indicated above, may optionally include the liquid catalyst recycle in addition to the pre-heater 110.

Alternatively, the catalyst may also be distributed throughout the reactor 114, alone or in combination with the feature of a liquid catalyst solution 118. This may be done by installing a metal grating, or similar to as would be done with ratch rings in a distillation column of various sizes and shape. If this approach is used the reactor may open quickly so that most or all of the catalyst matrix may be easily and/or quickly ejected and replaced with fresh catalyst. In this example embodiment, larger stripes or pieces of graphite, graphene, and other carbon subspecies may be produced. The operating temperature may be between 950 to 1050 degrees centigrade.

The catalyst may also be introduced by wetting the walls of the reactor 114 with catalyst solution. The reactor 114 may operate at 950 to 1150 degrees centigrade with the gas feed being preheated to 500 degrees centigrade before entering the reactor. This approach may produce solid carbon comprising graphite and graphene of a mixture of sizes from 8 cm in length to 3 to 6 microns in length.

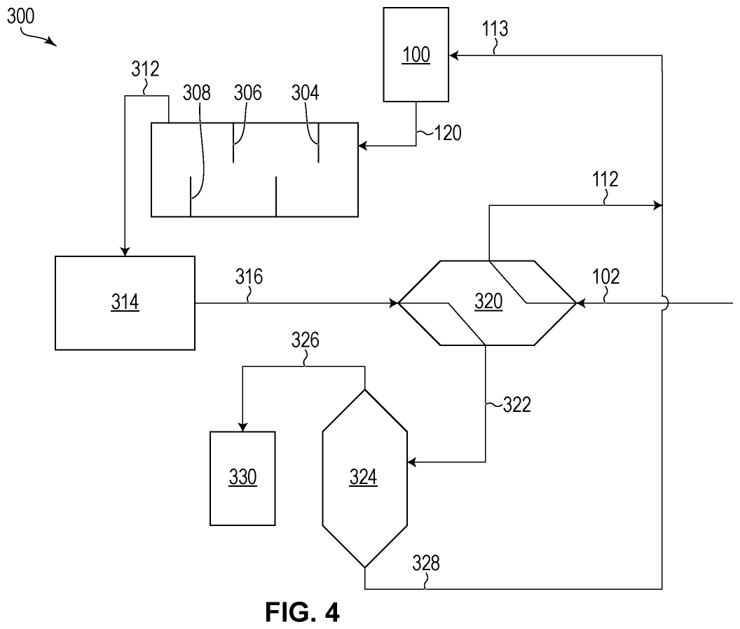

As shown in FIG. 4, the reactor system 100 may be part of a system for the production of solid carbon (e.g., graphite, graphene, carbon fibers, carbon nanotubes, fullerenes, and the like) and hydrogen 300. This system 300 may comprise a filtration system 306 that receives the output 120 of the reactor system 100. The filtration system 306 may include one or more filters that become progressively finer toward the outlet thereof (e.g., a coarse filter 304 and a fine filter 308). The filtration system 306 may optionally be closed and periodically opened to remove solid carbon (e.g., graphite, graphene, carbon fibers, carbon nanotubes, fullerenes, and the like) therefrom by, e.g., shaking or vibration, and may produce an outlet stream of gas which may contain trace amounts of solid carbon (e.g., graphite, graphene, carbon fibers, carbon nanotubes, fullerenes, and the like) (312) which optionally may be further filtered using an electrostatic filter 314, which may be emptied by e.g., shaking or vibration periodically. The substantially or completely solid carbon (e.g., graphite, graphene, carbon fibers, carbon nanotubes, fullerenes, and the like) free gas 316 may then be conveyed to a heat exchanger 320 to be cooled, producing cooled outlet gas 322 which may comprise hydrogen and methane. The outlet gas may then be conveyed into a filtration system such as a pressure swing absorption (PSA) system 324, producing hydrogen 326 which may be conveyed to storage 330. The PSA system 324 may also produce a recycled hydrocarbon feed 328 to be conveyed back to the reactor system 100. Optionally, the incoming feed 102 may be heated by the heat exchanger 320 to create a preheated stream 112 which may combine with the recycled stream 328 to produce a combined, recycled preheated stream 113. Optionally, the recycled preheated stream 113 may be further preheated within reactor system 100.

As indicated, a number of filters may be used to separate solid carbon (e.g., graphite, graphene, carbon fibers, carbon nanotubes, fullerenes, and the like) and hydrocarbon/hydrogen gas starting with a coarse filter, a finer filter, followed with yet another finer filter and so on until all carbon solid material has been removed. Each coarse filter may stop a portion of the fine carbon material and the final filter may be 1 micron or less and may operate in tandem with another or more filters so one is filtering while the other is cleaned. The final filter may have a dead area before it to let the carbon settle. An electrostatic precipitator separator may optionally be included.

Once the solid carbon is removed, the hydrocarbon stream (which may primarily be comprised of methane) and hydrogen gas may go to either a pressure swing absorption system or to a membrane separation system that separates the hydrogen and hydrocarbon gases. It may be that the membrane separation system provides hydrogen of up to or close to 99.99% pure hydrogen with all other gases being recycled back. Because gas separation systems tend to have difficulty with high temperatures, also provided may be a cooling phase before separation and a heating stage for the recycled hydrocarbon gases before returning to the feed gases for the reactor. Pipes may be used for heating and cooling or to use the incoming gas to heat the outgoing gas to the reactor. Any leftover heat may be used to heat original gas feed.

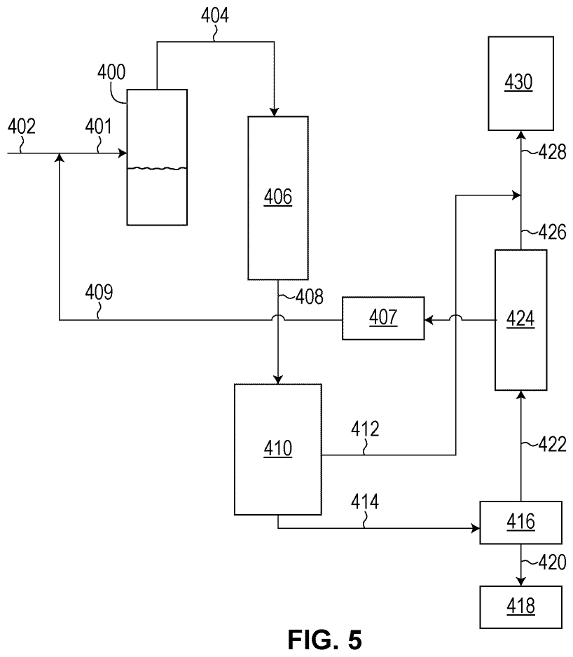

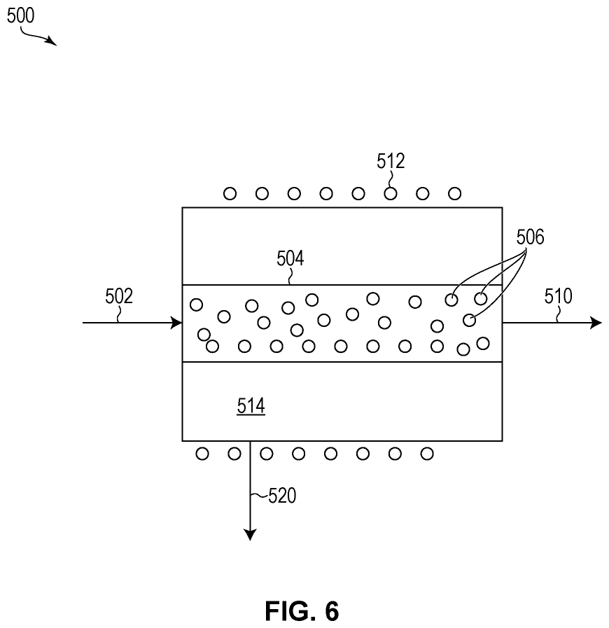

FIG. 5 illustrates another example embodiment of a system for producing solid carbon (e.g., graphite, graphene, carbon fibers, carbon nanotubes, fullerenes, and the like) and hydrogen, comprising a hydrocarbon feed 402 (as described above) which may optionally combine with a recycle stream to create feed 401 which may enter a fluid bed reactor 400 containing metal catalyst through which the feed 402 may pass to produce a mixture of solid carbon (e.g., graphite, graphene, carbon fibers, carbon nanotubes, fullerenes, and the like), hydrocarbon, hydrogen and other by products (stream 404). The reactor may, alternatively or in combination with catalyst fluid, include catalyst deposited on reactor walls, and/or may have catalyst in aerosol form mixed with the feed upon entry into the reactor 400. The stream 404 may then enter a pre-heater 406 which may be heated by any of the means discussed above, and may optionally include sonic elements to facilitate the passage of produced solids therethrough. The pre-heated stream 408 produced by the pre-heater 406 may then enter a further heater 410 which may include sonic elements (not shown) to facilitate the passage of produced solids therethrough, as previously mentioned. Any of the vessels described herein that may benefit from the inclusion of sonic elements (i.e., for creating vibration of the vessel) therein to facilitate passage of solids (e.g., graphite, graphene, carbon fibers, carbon nanotubes, fullerenes, and the like) therethrough may include such sonic elements. The heater 410 may optionally be a reactor, e.g., as described in FIG. 6, which produces a first hydrogen stream 412 and a first hydrogen, hydrocarbon and solid carbon (e.g., graphite, graphene, carbon fibers, carbon nanotubes, fullerenes, and the like) output stream 414. The stream 414 may be passed to a solids separator 416 (which may be any vessel suitable to separate solid carbon from hydrocarbons and residual hydrogen) which may in turn produce solids 420 for storage in solids storage unit 418. The separator 416 may also produce a hydrogen and hydrocarbon stream 422 that may then enter a hydrocarbon/hydrogen separation unit 424 (which may be, e.g., a PSA unit), producing a purified hydrogen stream 426 that may be combined with the first hydrogen stream 412 and combined to create purified hydrogen stream for storage at hydrogen storage vessel 430. The separator may also produce a hydrocarbon recycle stream that may be passed through a compressor 407 to create a compressed hydrocarbon recycle stream 409 to be combined with the feed 402 to create the feed 401. As mentioned, the hydrogen stream 412 is optional and may be used alone or in combination with a reactor type vessel (e.g., as described with respect to FIG. 6) in addition to or in combination with the reactor vessel 400.

FIG. 6 illustrates a reactor which may be used as the heater 410 discussed above, or may be suitably implemented in the other processes described herein and variations above that would be apparent to those skilled in the art. The reactor 500 may receive a hydrocarbon feed 502 comprising primarily methane and which may also comprise other light hydrocarbon gases such as ethane and propane and optionally other suitable additives that may facilitate formation of graphene and other carbon subspecies, as discussed further above. The reactor may comprise a selective permeation reactor core 504 having metal, preferably ferrous catalytic packing 506 (e.g., the catalysts discussed above). The core 504 may be permeable to hydrogen gas which may exit the core 504 into a space 514 and/or directly from the reactor. The reactor may be heated by induction coils 512 as shown in FIG. 6 and/or using other suitable means. Product stream 510 comprising hydrocarbons, residual hydrogen and solid carbon (e.g., graphite, graphene, carbon fibers, carbon nanotubes, fullerenes, and the like) may exit from the core 504 and be sent for further processing (e.g., utilizing the processes/vessels described herein).

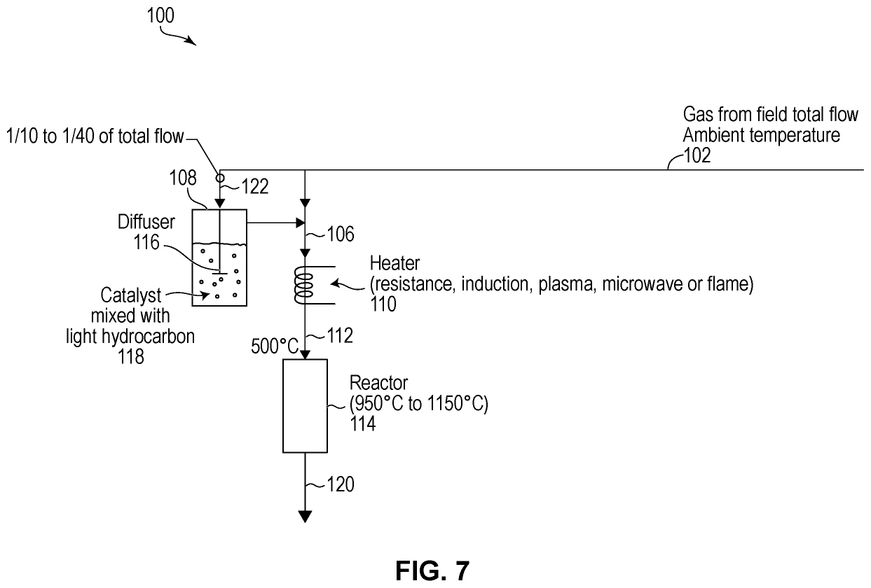

FIG. 7 is a more detailed version of a process similar to that illustrated in FIG. 3, including the same reference characters for similar elements, and additional details concerning process conditions (e.g., temperature, pressure and flow rate ratio of stream 122).

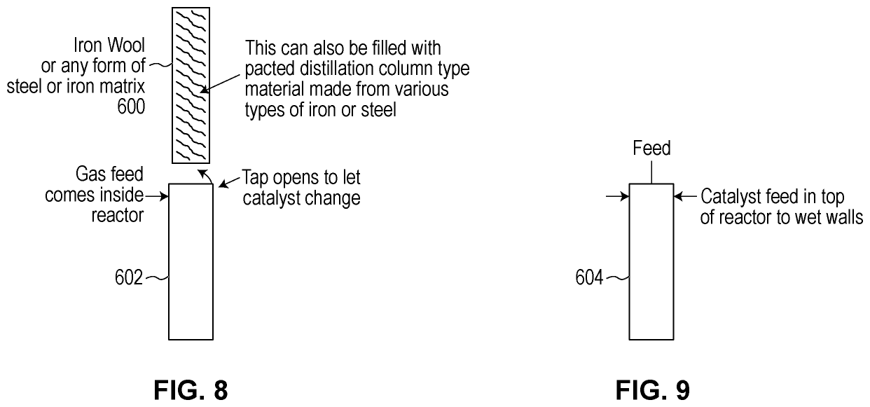

FIG. 8 illustrates an example embodiment of a reactor vessel 600 in which a hydrocarbon feed (e.g., feed 102) may be converted into solid carbon (e.g., graphite, graphene, carbon fibers, carbon nanotubes, fullerenes, and the like), hydrogen and residual hydrocarbons. Vessel 600 may contain iron wool or another form of metal matrix to facilitate conversion of hydrocarbons to solid carbon (e.g., graphite, graphene, carbon fibers, carbon nanotubes, fullerenes, and the like). The vessel 602 is a drawing of the vessel 600, but showing how the gas feed may enter the side of the reactor, and the top of the reactor may open to change the catalyst matrix and/or packing as needed.

FIG. 9 illustrates another example embodiment of a reactor vessel 604 for catalytic pyrolysis of hydrocarbons into hydrogen and solid carbon (e.g., graphite, graphene, carbon fibers, carbon nanotubes, fullerenes, and the like) wherein the catalyst may be introduced into the top of the reactor to be deposited on the reactor walls. As shown, the feed may (e.g., feed 102) may enter the top of the vessel 604.

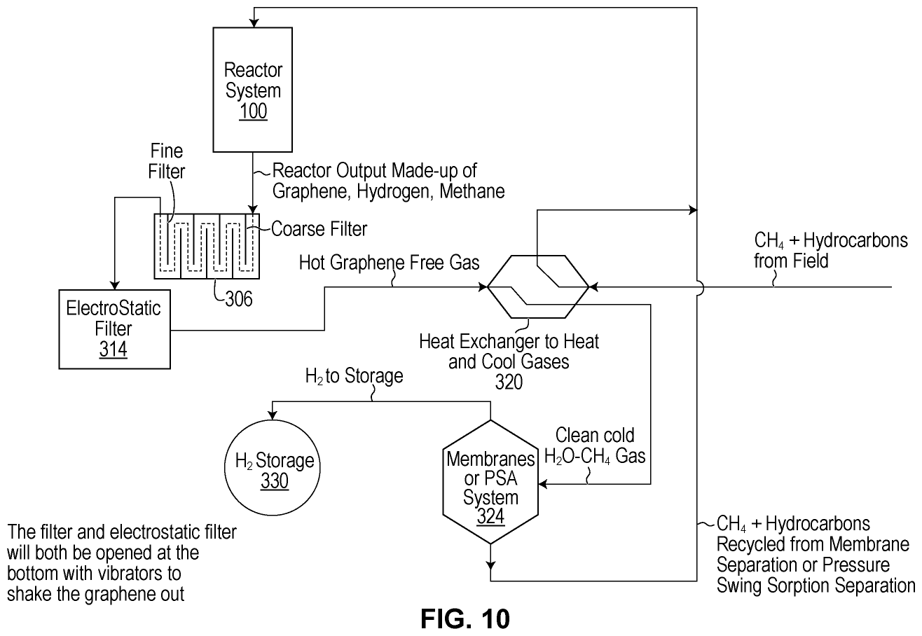

FIG. 10 is a more detailed version of a process similar to that illustrated in FIG. 4, including the same reference characters for similar elements, and additional details concerning process conditions (e.g., temperature, pressure and flow rate ratio of stream 122.

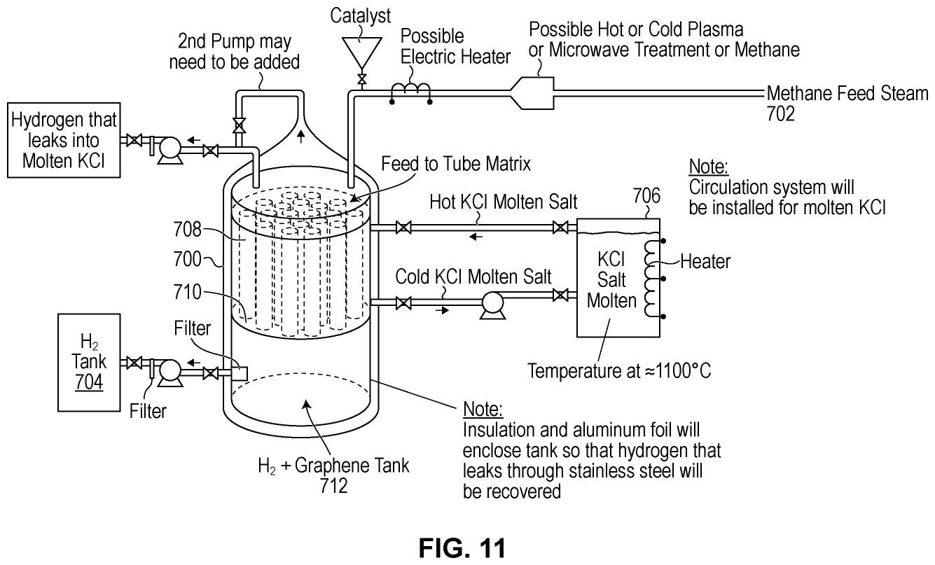

FIG. 11 illustrates another example embodiment of a process for the catalytic conversation of a hydrocarbon feed 702, which may primarily consist of methane, into hydrogen and solid carbon (e.g., graphite, graphene, carbon fibers, carbon nanotubes, fullerenes, and the like). As illustrates, the feed 702 may be heated and may have catalyst introduced therein, after which it may enter a reaction vessel 700. The heated feed combined with the catalyst may enter a matrix of tubes 708 wherein the hydrocarbon may be headed by the surrounding space 710, similar to a shell and tube heat exchanger arrangement. A heated fluid may be circulated through the space 710 after being heated by, e.g., heater 706. The heated fluid may be, for example, molten salts. Hydrogen and solid carbon (e.g., graphite, graphene, carbon fibers, carbon nanotubes, fullerenes, and the like) may collect in a tank 712, and the hydrogen may be removed therefrom to hydrogen storage.

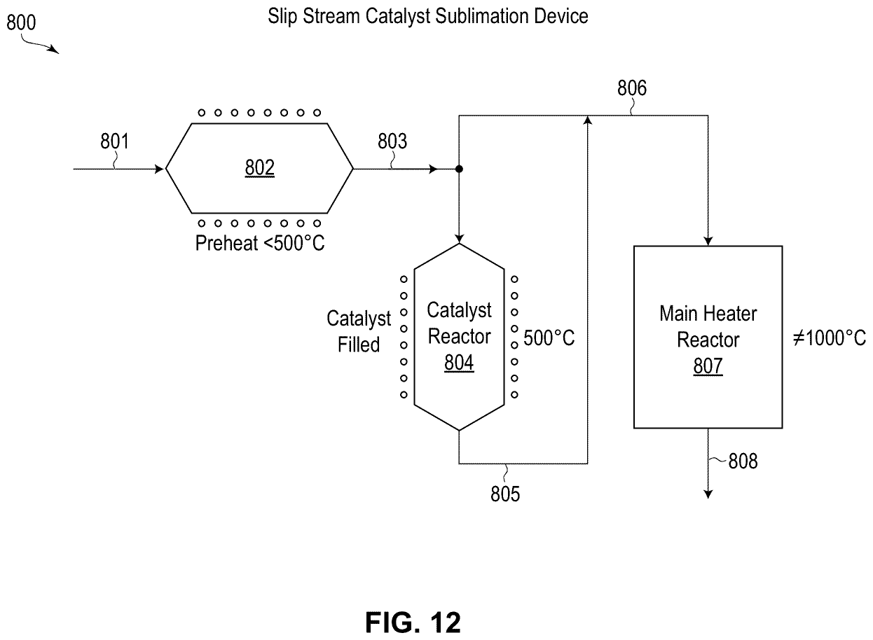

FIG. 12 illustrates a process 800 for sublimation of ferrocene into a non combustion process methane stream (pyrolysis). Light hydrocarbon feedstock, or process gas 801 (defined above) may be introduced into a pre-heater 802 whereby the process gas 801 may be pre-heated to above 500 degrees centigrade to create a pre-heated stream 803. The pre-heated stream 803 may be introduced into a pressurized vessel or device (first reactor 804) which may be a catalytic reactor. The first reactor 804 may be heated externally and filled with solid ferrocene and/or other suitable metallic catalytic compounds, which may be present as, for example, solid particles. The first reactor 804 may be heated by, for example, resistive or inductive methods to heat the ferrocene therein to above its sublimation temperature, which may vary according to the pressure in the first reactor 804. The temperature in the first reactor 804 may be maintained at, for example, 500 degrees centigrade. The pre-heated stream 803 may be introduced at one end of the first reactor 804 and contact the heated ferrocene therein. A mixture comprising saturated gas and sublimated ferrocene 805 may then exit the first reactor 804 and be re-introduced to the pre-heated stream 803 to create a feed stream 806 for a second reactor 807 which may operate at, for example 1000 degrees centigrade. Pyrolysis may occur in the second reactor 807, thereby creating a product mixture 808 comprising solid carbon (e.g., graphite, graphene, carbon fibers, carbon nanotubes, fullerenes, and the like), hydrogen and residual hydrocarbons. Separation of at least hydrogen from the product mixture 808 may occur downstream.

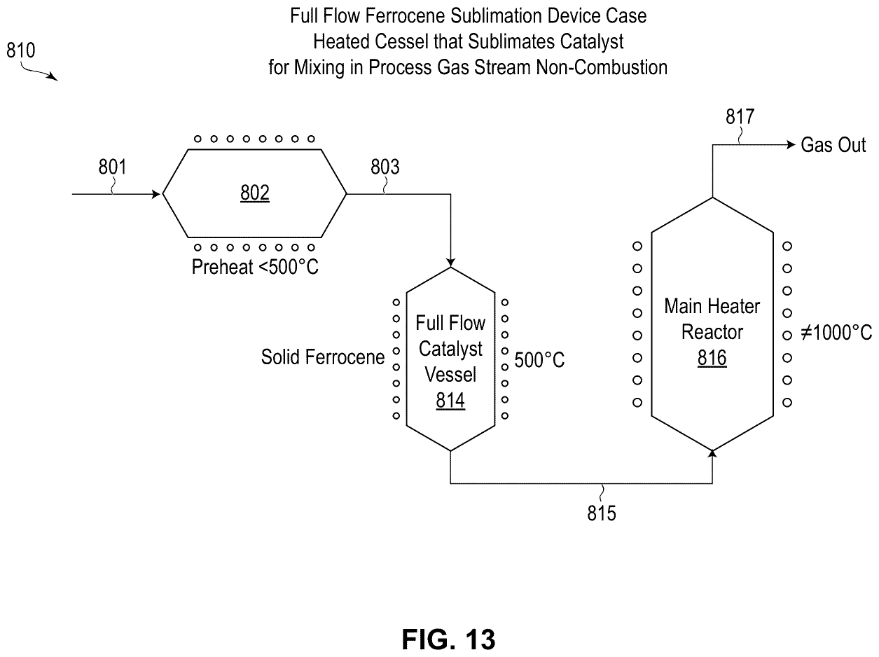

FIG. 13 illustrates a process 810 differing from process 800 in that instead of a slip stream or partial mass flow through a smaller catalyst sublimation device (i.e., first reactor 804), process 810 includes a first reactor 814 vessel large enough to create a mixture 815 comprising saturated gas and sublimated ferrocene that can be fed directly to a second, or main reactor 816. The main reactor 816 may be operated at, for example, 1000 degrees centigrade, and may create a product mixture 817 comprising solid carbon (e.g., graphite, graphene, carbon fibers, carbon nanotubes, fullerenes, and the like)), hydrogen and residual hydrocarbons.

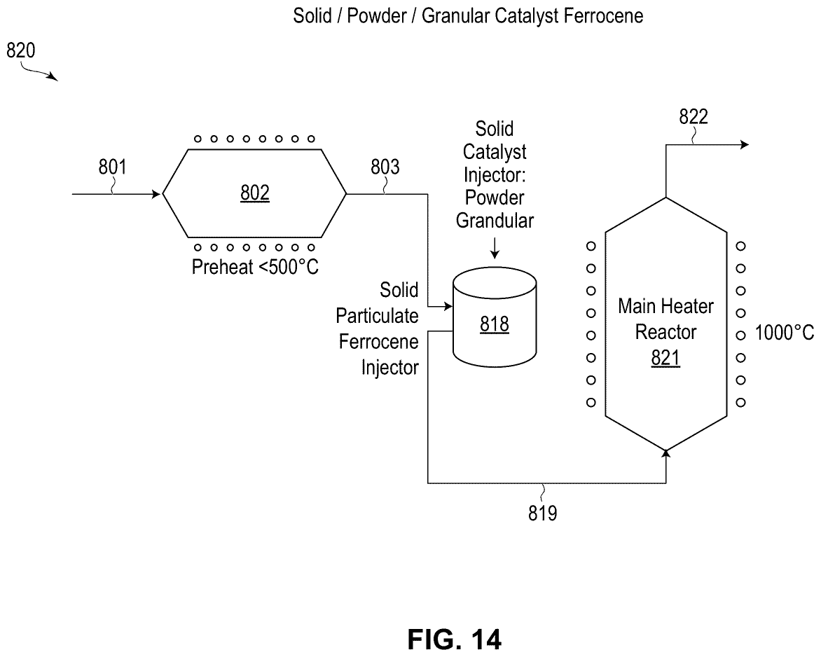

FIG. 14 illustrates another process 820 for catalytic pyrolysis of light hydrocarbons to create solid carbon (e.g., solid carbon and/or hydrogen). In the process 820, solid particulate ferrocene may be introduced into the pre-heated stream 803 for a non combustion pyrolysis reaction. In the process 820, device(s) 818 may introduce solid particulate ferrocene and/or similar catalytic compounds into the pre-heated stream 803 to assist in the conversion of light hydrocarbons (e.g., methane) to hydrogen and solid carbon particulates. Such device(s) 818 may use vibration or sonic tools to suspend particulate to be swept up in the methane process stream to create a feed stream 819 for sublimation and reaction in a main pyrolysis reactor 821. The device(s) 818 may comprise, e.g., a venturi delivery system and a grind wheel. The reactor 821 may create a product mixture 822 comprising solid carbon (e.g., graphite, graphene, carbon fibers, carbon nanotubes, fullerenes, and the like)), hydrogen and residual hydrocarbons.

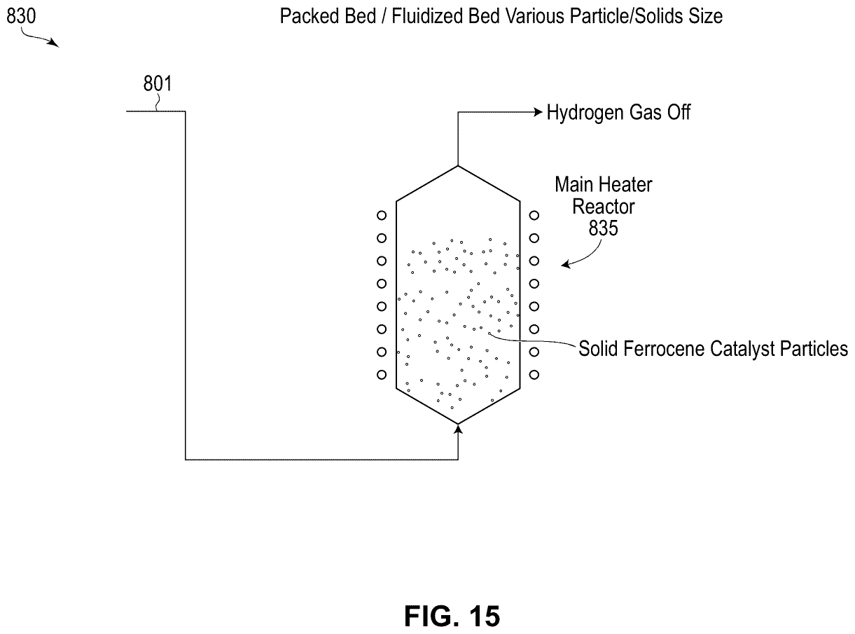

FIG. 15 illustrates yet another process 830 for catalytic pyrolysis of light hydrocarbons to create solid carbon (e.g., graphite, graphene, carbon fibers, carbon nanotubes, fullerenes, and the like) and hydrogen. The process 830 comprises a main reactor 835 that may be, for example, a packed bed reactor whereby a pressure vessel is filled with solid ferrocene and heated with resistive or inductive methods. The process gas stream 801 may optionally not be pre-heated, and may introduced into the main reactor 835 wherein catalytic pyrolysis may occur. The ferrocene particles may vary in size and may be a source of heat exchange (i.e., a heat source for the light hydrocarbons in the reactor 835) in addition to catalyzing pyrolysis.

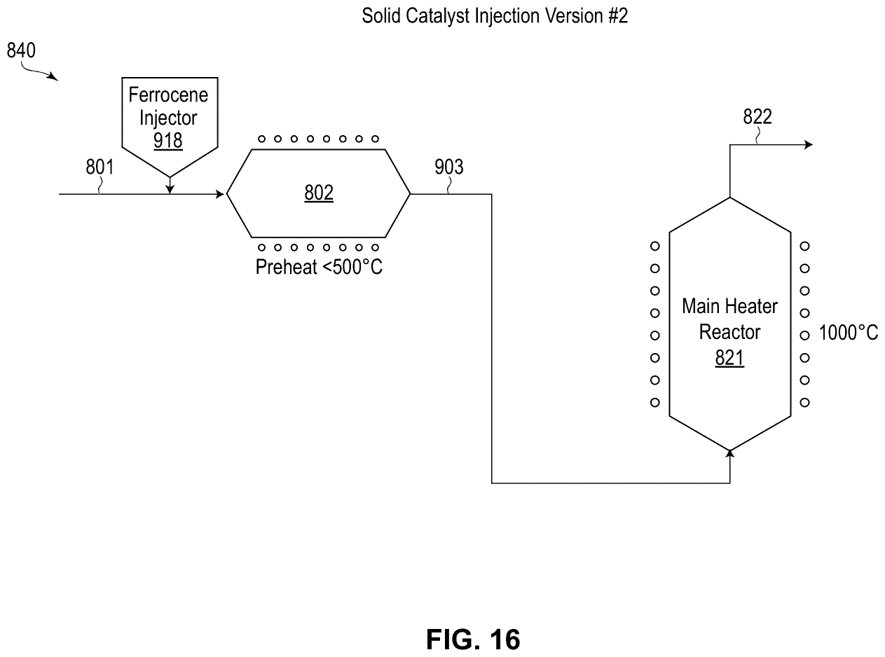

FIG. 16 illustrates yet another process 840 for catalytic pyrolysis of light hydrocarbons to create solid carbon (e.g., graphite, graphene, carbon fibers, carbon nanotubes, fullerenes, and the like) and hydrogen. The process 840 is similar to the process 820, but differs in that one or more devices 918 for introducing solid particulate ferrocene and/or similar catalytic compounds are situated prior to the pre-heater 802 which may be operated at, for example, 500 degrees centigrade. Exiting the pre-heater 802 is a feed stream 903 for the reactor 821, the feed stream 903 comprising heated light hydrocarbons and catalytic particles/compounds suspended therein. In some embodiments, the one or more devices 918 may be located before and/or after the pre-heater 802.

In some embodiments, the main reactor 835 may be a fluidized bed reactor. In embodiments where a fluidized bed is used, as compared to ferrocene used in the packed bed reactor, the solid ferrocene particles may be smaller and suspended in the light hydrocarbon gas stream within the reactor 835. Such suspended particles may be removed from the pressure containment vessel (reactor 835) by, for example, distillation or mechanical separation. In some embodiments, heat from the gaseous component of the product stream (i.e., the exhaust from the pyrolysis reactor), may be used alone or in combination with the pre-heater to heat the incoming process gas.

The vessels described above with respect to FIGS. 12 to 16 may be heated inductively, resistively, or by any other suitable method (e.g., the alternative methods discussed above). Metallic catalytic compounds (e.g., other ferrous catalysts) may be used alternatively to or in combination with ferrocene in the processes described herein.

It will be understood that the term “metallic catalytic compound” as used herein refers to any catalytic compound that may catalyze the pyrolysis of hydrocarbons. It was found that use of ferrocene alone as a catalytic compound produced surprising results. It has been found that the use of ferrocene alone as a metallic catalytic compound may substantially increase the efficiency of light hydrocarbon pyrolysis while also reducing reactor fouling. In some cases, the use of ferrocene alone approximately doubled the efficiency of light hydrocarbon pyrolysis. Benefits of using ferrocene in part, rather than alone, also produced improved results.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

The examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method for producing solid carbon and hydrogen, the method comprising:
heating a hydrocarbon feed comprising light hydrocarbons to about 500 °C to create a pre heated hydrocarbon feed;
in a first reactor, heating one or more metallic catalytic compounds to above a sublimation temperature of the one or metal catalytic compounds;
introducing a portion of the pre heated hydrocarbon feed to the first reactor wherein the light hydrocarbons react with the one or more metallic catalytic compounds to produce a mixture comprising light hydrocarbon gas and one or more sublimated metallic catalytic compounds;
combining with the preheated hydrocarbon feed the mixture comprising light hydrocarbon gas and the sublimated one or more metallic catalytic compounds to produce a reactor feed stream; and
introducing the main reactor feed to a second reactor operated at about 1000 °C to create a product mixture comprising hydrogen and the solid carbon.

2. A method for producing solid carbon and hydrogen, the method comprising:
heating a hydrocarbon feed comprising light hydrocarbons to about 500 °C to create a pre heated hydrocarbon feed;
in a first reactor, heating one or more metallic catalytic compounds to above a sublimation temperature of the one or more metallic catalytic compounds;
introducing the pre heated hydrocarbon feed to the first reactor wherein the light hydrocarbons react with the one or more metallic catalytic compounds to produce a reactor feed stream comprising light hydrocarbon gas and sublimated metallic catalytic compounds; and
introducing the reactor feed stream to a second reactor operated at about 1000 °C to create a product mixture comprising the solid carbon and the hydrogen.

3. A method for producing solid carbon and hydrogen, the method comprising:
heating a hydrocarbon feed comprising light hydrocarbons to about 500 °C to create a pre heated hydrocarbon feed;
introducing solid particles comprising one or more metallic catalytic compounds into the pre heated hydrocarbon feed and using vibration or ultra sonic tools to suspend the solid particles in the pre heated hydrocarbon feed, thereby creating a reactor feed stream; and
introducing the reactor feed stream to a second reactor operated at about 1000 °C to create a product mixture comprising the hydrogen and the solid carbon.

4. A method for producing solid carbon and hydrogen, the method comprising:
introducing a hydrocarbon feed stream comprising light hydrocarbons into a catalytic pyrolysis reactor, wherein the reactor is:
a packed bed reactor containing solid particles comprising metallic catalytic compounds, the solid particles having a size of from about 5 mm to about 50 mm; or
a fluidized bed reactor containing solid particles comprising metallic catalytic compounds, the solid particles a size of from about 1 mm to about 10 mm;
to produce a product mixture comprising the hydrogen and the solid carbon.

5. The method of claim 1, wherein the one or more metallic catalytic compounds comprise iron or ferrocene.

6. The method of claim 1, wherein the solid carbon comprises graphene, graphite, carbon nanotubes, carbon fibers, and/or fullerenes.

7. The method of claim 1, wherein the light hydrocarbons comprise methane.

8. The method of claim 2, wherein the one or more metallic catalytic compounds comprise iron or ferrocene.

9. The method of claim 2, wherein the solid carbon comprises graphene, graphite, carbon nanotubes, carbon fibers, and/or fullerenes.

10. The method of claim 2, wherein the light hydrocarbons comprise methane.

11. The method of claim 3, wherein the one or more metallic catalytic compounds comprise iron or ferrocene.

12. The method of claim 3, wherein the solid carbon comprises graphene, graphite, carbon nanotubes, carbon fibers, and/or fullerenes.

13. The method of claim 3, wherein the light hydrocarbons comprise methane.

14. The method of claim 4, wherein the one or more metallic catalytic compounds comprise iron or ferrocene.

15. The method of claim 4, wherein the solid carbon comprises graphene, graphite, carbon nanotubes, carbon fibers, and/or fullerenes.

16. The method of claim 4, wherein the light hydrocarbons comprise methane.

17. An apparatus for the catalytic pyrolysis of light hydrocarbons, the apparatus comprising:
a first end and a second end, the first end being configured to receive a feed comprising the light hydrocarbons;
a channel defined therein for conveying a fluid between the first and second ends, wherein the fluid is a reaction mixture comprising the light hydrocarbons, wherein the channel is defined by a material permeable to hydrogen;
the channel including solid particles comprising one or more metallic catalytic compounds for catalytic conversion of the light hydrocarbons to hydrogen and solid carbon; and
a compartment or outlet for removing hydrogen that passes through the material permeable to hydrogen.

18. The apparatus of claim 17, wherein the one or more metallic catalytic compounds comprise iron or ferrocene.

19. The apparatus of claim 17, wherein the solid carbon comprises graphene, graphite, carbon nanotubes, carbon fibers, and/or fullerenes.

20. The apparatus of claim 17, wherein the light hydrocarbons comprise methane.
